(19) United States
(12) Patent Application Publication
(10) Pub. No.: US 2010/0027306 A1
(43) Pub. Date: Feb. 4, 2010

(54) PRIMARY RESONANT INVERTER CIRCUIT FOR FEEDING A SECONDARY CIRCUIT

(75) Inventors: Christoph Loef, Eindhoven (NL); Thomas Scheel, Eindhoven (NL); Christian Hattrup, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N V, Eindhoven (NL)

(21) Appl. No.: 12/439,893

(22) PCT Filed: Oct. 9, 2007
(86) PCT No.: PCT/IB07/54105

§ 371 Date: Mar. 4, 2009

(30) Foreign Application Priority Data
Oct. 13, 2006 (EP) 06122241.0

(51) Int. Cl. H02M 7/5387

(52) U.S. Cl. 363/132

(57) ABSTRACT

A primary circuit (1) for feeding a secondary circuit (2) comprises a switch circuit (10) with switches (11-14) controlled by a control circuit (40) for bringing the primary circuit (1) into first or second modes and comprises a resonance circuit (20) for, in the first mode, increasing an energy supply from a source (4) to the secondary circuit (2) via in-phase resonance circuit voltages and currents and for, in the second mode, not increasing the energy supply to the secondary circuit (2) via not-in-phase resonance circuit voltages and currents and comprises (basic idea) a converter circuit (30) for converting a primary circuit signal into a control signal for the control circuit (40) for bringing the primary circuit (10) into the first mode or into the second mode in dependence of the control signal, according to a zero current switching strategy for reducing losses and electromagnetic interference.

### FIELD OF THE INVENTION

The invention relates to a primary circuit for feeding a secondary circuit, and also relates to a supply circuit comprising a primary circuit, to a device comprising a supply circuit, to a method, to a computer program product and to a medium.

Examples of such a primary circuit are half-bridge and full-bridge inverters coupled to resonance circuits, without excluding other primary circuits. Examples of such a supply circuit are switched mode power supplies, without excluding other supply circuits. Examples of such a device are consumer products and non-consumer products, without excluding other products.

### BACKGROUND OF THE INVENTION

U.S. Pat. No. 5,719,759 discloses a DC/AC converter with equally loaded switches.

### SUMMARY OF THE INVENTION

It is an object of the invention, inter alia, to provide a primary circuit for feeding a secondary circuit, which primary circuit comprises a control that does not require a feedback loop from the secondary circuit to the primary circuit.

Further objects of the invention are, inter alia, to provide a supply circuit comprising a primary circuit, a device comprising a supply circuit, a method, a computer program product and a medium, that comprise a control that does not require a feedback loop from the secondary circuit to the primary circuit.

The primary circuit feeds the secondary circuit and comprises
a switch circuit comprising switches controlled by a control circuit for bringing the primary circuit at least into a first mode or into a second mode,
a resonance circuit for, in the first mode, increasing an energy supply from a source to the secondary circuit via (by means of) a first voltage across the resonance circuit and a first current through the resonance circuit that are in phase with each other and for, in the second mode, not increasing the energy supply to the secondary circuit via (by means of) a second voltage across the resonance circuit and a second current through the resonance circuit that are not in phase with each other, and
a converter circuit for converting a primary circuit signal into a control signal for the control circuit for bringing the primary circuit into the first mode or into the second mode in dependence of the control signal.

The switch circuit comprises for example an inverter. The resonance circuit comprises for example a serial circuit of a capacitor and an inductor. Via this inductor, for example in the form of a transformer, energy can be supplied to a load. The control circuit controls the switches of the switch circuit to bring the primary circuit into the first or second mode.

In the first mode, the switch circuit couples the resonance circuit to the source in such a way that a first voltage across the resonance circuit and a first current through the resonance circuit are in phase with each other. As a result, the energy supply from the source to the secondary circuit via the switch circuit and the resonance circuit is increased. In the second mode, the switch circuit couples the resonance circuit to the source in such a way that a second voltage across the resonance circuit and a second current through the resonance circuit are not in phase with each other. As a result, the energy supply from the source to the secondary circuit via the switch circuit and the resonance circuit is not increased. The converter circuit converts the primary circuit signal into the control signal for (setting) the control circuit.

So, an internal signal of the primary circuit, such as a signal in the switch circuit or a signal in the resonance circuit, is used for defining a mode of the primary circuit, and the mode of this primary circuit defines an amount of energy flowing through the primary circuit. As a result, a disadvantageous feedback loop from the load to the primary circuit is no longer necessary and can be avoided.

An embodiment of the primary circuit according to the invention is defined by claim 2. In the second mode, according to a first option, the switch circuit couples the resonance circuit to the source in such a way that a second voltage across the resonance circuit and a second current through the resonance circuit are in anti-phase with each other (special case of being not in phase). As a result, energy is supplied back from the resonance circuit to the source (special case of the energy supply from the source to the secondary circuit being not increased). In the second mode, according to a second option, the switch circuit couples the resonance circuit to the source in such a way that a fixed voltage such as a zero voltage is present across the resonance circuit (special case of being not in phase with the current through the resonance circuit). As a result, the energy supply from the source to the secondary circuit and/or a supply of energy back to the source is blocked (special case of the energy supply from the source to the secondary circuit being not increased).

To preferably realize a zero current switching strategy for reducing losses and electromagnetic interference, the current flowing from the switch circuit to the resonance circuit should be zero at the switching instants of the switches of the switch circuit. Thereto, the voltage across the resonance circuit and the current through the resonance circuit should be either in phase with each other or should be in anti-phase with each other or should not have any phase relationship by for example giving this voltage a fixed such as a zero value.

An embodiment of the primary circuit according to the invention is defined by claim 3. The switch circuit may be a full bridge inverter the first mode may be an energy supplying state of the full bridge inverter and the second mode may be either an idle state of the full bridge inverter or an energy retrieving state of the full bridge inverter.

An embodiment of the primary circuit according to the invention is defined by claim 4. The primary circuit signal may be the current through the resonance circuit, a first group of values of the control signal for example situated below a first threshold may result in the energy supplying state, a second group of values of the control signal for example situated between the first threshold and a second threshold may result in the idle state, and a third group of values of the control signal for example situated above the second threshold may result in the energy retrieving state. Other primary circuit signals are not to be excluded, such as an electrical field and/or a magnetic field at a location somewhere in/near the primary circuit.

An embodiment of the primary circuit according to the invention is defined by claim 5. The switch circuit may be a half bridge inverter the first mode may be an energy supplying state of the half bridge inverter and the second mode may be an energy retrieving state of the half bridge inverter.

An embodiment of the primary circuit according to the invention is defined by claim 6. The primary circuit signal may be the current through the resonance circuit, a fourth group of values of the control signal for example situated below a third threshold may result in the energy supplying state, and a fifth group of values of the control signal for example situated above the third threshold may result in the energy retrieving state.

An embodiment of the primary circuit according to the invention is defined by claim 7. Preferably, but not exclusively, the control signal is a low-pass filtered (possibly weighted) absolute value of the current through the resonance circuit.

The supply circuit is defined by claim 8. An embodiment of the supply circuit is defined by claim 9. The secondary circuit provides an output signal to a load, and the average output signal depends on a number of first states versus a number of second states.

The device is defined by claim 10. The load for example comprises one or more light emitting diodes and/or one or more strings of light emitting diodes.

The method is defined by claim 11. The computer program product is defined by claim 12. The medium such as a memory or a disk or a stick is defined by claim 13.

Embodiments of the supply circuit and of the device and of the method and of the computer program product and of the medium correspond with the embodiments of the primary circuit.

An insight might be, inter alia, that in a primary circuit for feeding a secondary circuit, a signal inside the primary circuit can be used for controlling this primary circuit and for avoiding a control of the primary circuit via a feedback loop from the secondary circuit to the primary circuit.

A basic idea might be, inter alia, that, for different modes of a primary circuit, different amounts of energies may flow through the primary circuit, and that the different modes are to be selected in response to a signal coming from the primary circuit.

A problem, inter alia, to provide a primary circuit for feeding a secondary circuit, which primary circuit comprises a control that does not require a feedback loop from the secondary circuit to the primary circuit, is solved.

These and other aspects of the invention will be apparent from and elucidated with reference to the embodiments(s) described hereinafter.

### BRIEF DESCRIPTION OF THE DRAWINGS

In the drawings:

FIG. 1 shows diagrammatically a device according to the invention comprising a supply circuit according to the invention that comprises a primary circuit according to the invention and a secondary circuit,

FIG. 2 shows diagrammatically in greater detail a primary circuit according to the invention that comprises a switch circuit, a resonance circuit, a converter circuit and a control circuit,

FIG. 3 shows diagrammatically in greater detail a switch circuit and a resonance circuit,

FIG. 4 shows a voltage across and a current through elements of the resonance circuit, and

FIG. 5 shows diagrammatically in greater detail a converter circuit.

### DETAILED DESCRIPTION OF EMBODIMENTS

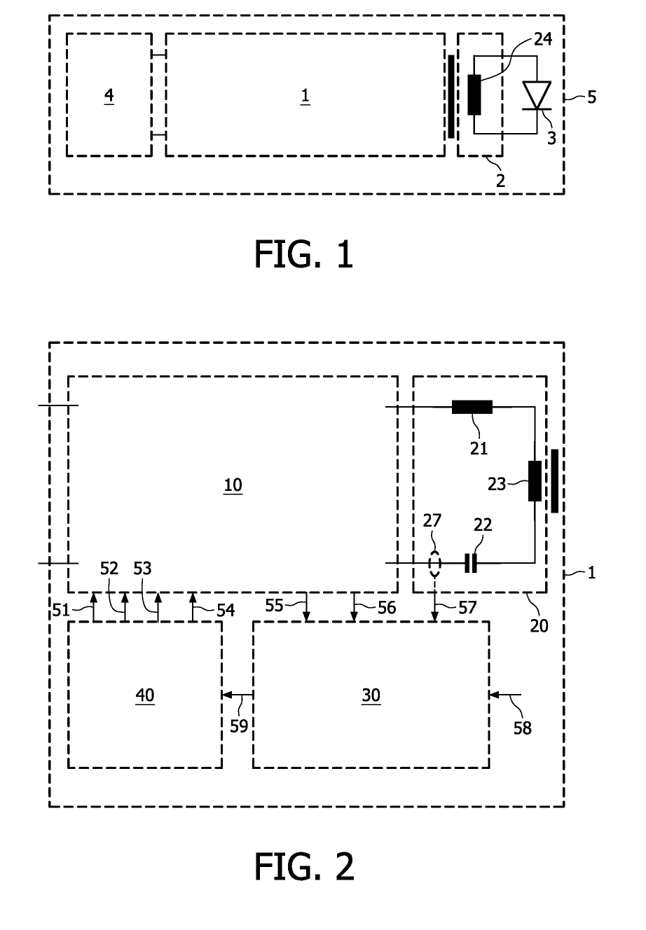

The device 5 according to the invention shown in the FIG. 1 comprises a source 4 such as for example a battery for providing a DC voltage or a rectifier for rectifying an AC voltage into a rectified AC voltage. Outputs of the source 4 are coupled to inputs of a primary circuit 1 for feeding a secondary circuit 2. Outputs of the secondary circuit 2 are coupled to a load 3, such as for example one or more light emitting diodes and/or one or more strings of light emitting diodes. Energy is for example transferred via a transformer 23,24 shown partly in the FIG. 1 and shown partly in the FIG. 2. Alternatively, a single inductor could be used for this transfer, whereby for example the entire inductor forms part of the primary circuit 1 and only a part of this inductor situated between one side of this inductor and a tap of this inductor forms part of the secondary circuit 2.

The load 3 may be coupled directly to the transformer 23,24 or indirectly via one or more rectifying diodes and/or indirectly via one or more resistors for allowing different (strings of) light emitting diodes to be controlled individually.

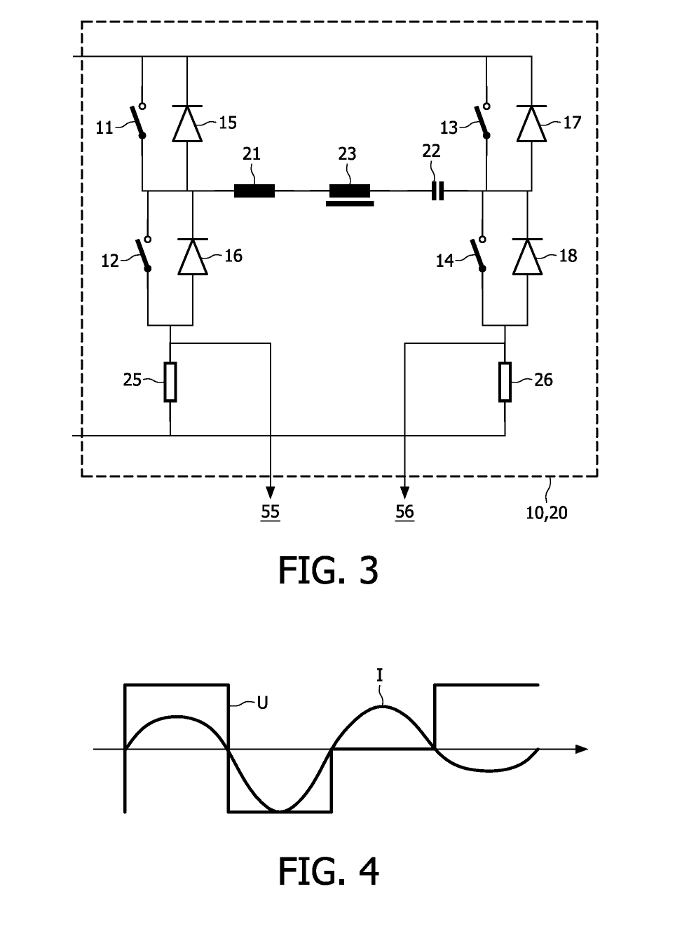

The primary circuit 1 shown in the FIG. 2 in greater detail comprises a switch circuit 10 such as for example a half-bridge inverter or a full-bridge inverter shown in greater detail in the FIG. 3. Inputs of the switch circuit 10 form the inputs of the primary circuit 1 and outputs of the switch circuit 10 are coupled to inputs of a resonance circuit 20. This resonance circuit 20 comprises for example a serial circuit of a capacitor 22 and an inductor 21,23. This inductor 21,23 for example comprises a stray inductance of the transformer 23,24 and an optional inductor 21. The primary circuit 1 further comprises a converter circuit 30 and a control circuit 40.

Via at least one of two connections 55,56 or alternatively via a connection 57, the converter circuit 30 receives a primary circuit signal, and via a connection 58 the converter circuit 30 receives a reference value, and via a connection 59 the converter circuit 30 supplies a control signal to the control circuit 40. The control circuit 40 supplies four switching signals via connections 51-54 to the switch circuit 10 in case this switch circuit 10 comprises four switches (full-bridge) or supplies two switching signals via connections 51-54 to the switch circuit 10 in case this switch circuit 10 comprises two switches (half-bridge).

The switch circuit 10 and the resonance circuit 20 shown in the FIG. 3 in greater detail comprise a positive voltage rail for example coupled to a positive output of the source 4 and negative voltage rail for example coupled to a negative output of the source 4. The positive voltage rail is coupled to first sides of switches 11, 13 such as for example transistors and to cathodes of diodes 15,17. The negative voltage rail is, in a prior art situation, coupled to second sides of switches 12,14 such as for example transistors and to anodes of diodes 16,18. A second side of the switch 11 is coupled to a first side of the switch 12 and to an anode of the diode 15 and to a cathode of the diode 16 and to a first side of the serial circuit 21-23. A second side of the switch 13 is coupled to a first side of the switch 14 and to an anode of the diode 17 and to a cathode of the diode 18 and to a second side of the serial circuit 21-23.

The control circuit 40 controls the switches 11-14 of the switch circuit 10 to bring the primary circuit 1 into the first or second mode. In the first mode (an energy supplying state of the full-bridge inverter or the half-bridge inverter), the switch circuit 10 couples the resonance circuit 20 to the source 4 in such a way that a first voltage across the resonance circuit 20 and a first current through the resonance circuit 20 are in phase with each other. As a result, the energy supply from the source 4 to the secondary circuit 2 via the switch circuit 10 and the resonance circuit 20 is increased. In the second mode (an idle state of the full-bridge inverter or an energy retrieving state of the full-bridge inverter or the half-bridge inverter), the switch circuit 10 couples the resonance circuit 20 to the source 4 in such a way that a second voltage across the resonance circuit 20 and a second current through the resonance circuit 20 are not in phase with each other. As a result, the energy supply from the source 4 to the secondary circuit 2 via the switch circuit 10 and the resonance circuit 20 is not increased, as further explained below. The converter circuit 30 converts the primary circuit signal into the control signal for (setting) the control circuit 40.

So, an internal signal of the primary circuit 1, such as a signal in the switch circuit 10 or a signal in the resonance circuit 20, is used for defining a mode of the primary circuit 1, and the mode of this primary circuit 1 defines an amount of energy flowing through the primary circuit 1. As a result, a disadvantageous feedback loop from the load 3 to the primary circuit 1 is no longer necessary and can be avoided.

For the second mode, the following options are possible. According to a first option (an energy retrieving state of the full-bridge inverter or the half-bridge inverter), the switch circuit 10 couples the resonance circuit 20 to the source 4 in such a way that a second voltage across the resonance circuit 20 and a second current through the resonance circuit 20 are in anti-phase with each other (special case of being not in phase). As a result, energy is supplied back from the resonance circuit 20 to the source 4 (special case of the energy supply from the source 4 to the secondary circuit 2 being not increased). According to a second option (an idle state of the full-bridge inverter), the switch circuit 10 couples the resonance circuit 20 to the source 4 in such a way that a fixed voltage such as a zero voltage is present across the resonance circuit 20 (special case of being not in phase with the current through the resonance circuit 20). As a result, the energy supply from the source 4 to the secondary circuit 2 and/or a supply of energy back to the source 4 is blocked (special case of the energy supply from the source 4 to the secondary circuit 2 being not increased).

To preferably realize a zero current switching strategy for reducing losses and electromagnetic interference, the current flowing from the switch circuit 10 to the resonance circuit 20 should be zero at the switching instants of the switches 11-14 of the switch circuit 10. Thereto, the voltage across the resonance circuit 20 and the current through the resonance circuit 20 should be either in phase with each other or should be in anti-phase with each other or should not have any phase relationship by for example giving this voltage a fixed such as a zero value.

The primary circuit signal is for example the current through the resonance circuit 20. The control signal may for example be a low-pass filtered absolute value or a low-pass filtered weighted absolute value of this current, without excluding other possibilities. The value of the control signal is for example compared with one or more threshold values. In case of a full-bridge inverter, a first group of values of the control signal for example situated below a first threshold may result in the energy supplying state, a second group of values of the control signal for example situated between the first threshold and a second threshold may result in the idle state, and a third group of values of the control signal for example situated above the second threshold may result in the energy retrieving state. In case of a half-bridge inverter a fourth group of values of the control signal for example situated below a third threshold may result in the energy supplying state, and a fifth group of values of the control signal for example situated above the third threshold may result in the energy retrieving state.

According to a first possibility (full-bridge), to derive such a current from the switch circuit 10, the negative voltage rail is to be coupled to the switch 12 and the diode 16 via a first resistor 25 and is to be coupled to the switch 14 and the diode 18 via a second resistor 26. The coupling between the first resistor 25 and the switch 12 and the diode 16 is then to be coupled to the connection 55, and the coupling between the second resistor 26 and the switch 14 and the diode 18 is then to be coupled to the connection 56. According to a second possibility (half-bridge), only one of the resistors 25 and 26 and only one of the connections 55 and 56 is to be used. According to a third possibility, a current flowing between the switch circuit 10 and resonance circuit 20 is to be measured via a measurement loop 27 coupled to the connection 57. Further possibilities are not to be excluded.

In the FIG. 4, a voltage U across and a current I through elements 21-23 of the resonance circuit 20 are shown. In the first state (energy flows from the source 4 to the resonance circuit 20), a positive voltage pulse and a positive current that is in phase with the positive voltage pulse are followed by a negative voltage pulse and a negative current that is in phase with the negative voltage pulse etc. Then the primary circuit 1 is brought into the second state (an idle state to be realized by means of a full-bridge inverter) defined by a fixed voltage across the elements 21-23 such as a zero voltage whereby a current is still flowing. Finally, in the third state (energy flows back from the resonance circuit 20 to the source 4), a positive voltage pulse and a negative current that is in anti-phase with the positive voltage pulse are followed by a negative voltage pulse and a positive current that is in anti-phase with the negative voltage pulse etc.

In the first state (energy flows from the source 4 to the resonance circuit 20), to realize the positive voltage pulse, the switches 11 and 14 are brought into a conducting state and the switches 12 and 13 are brought into a non-conducting state. In the first state, to realize the negative voltage pulse, the switches 11 and 14 are brought into a non-conducting state and the switches 12 and 13 are brought into a conducting state. In this case, energy is supplied from the source 4 via the primary circuit 1 to the secondary circuit 2. In the second state (idle state), to realize the zero voltage signal, the switch 11 is brought into a conducting state and the other switches are brought into a non-conducting state, whereby a loop is created via the conducting switch 11, the serial circuit 21-23 and the diode 17. Alternatively, this may be done via the switch 12 (13,14) and the diode 18 (15,16). In this case, resistive losses will be responsible for dampening. In the third state (energy flows back from the resonance circuit 20 to the source 4), to realize the positive voltage pulse, the current will flow via the diode 15, the source 4 and the diode 18, and to realize the negative voltage pulse, the current will flow via the diode 17, the source 4 and the diode 16. In this case, dampening is realized by means of energy retrieving. Of course, to make this possible, the (resonance) voltage pulse should be larger than a voltage value of the source 4. Further, a switch coupled in parallel to a conducting diode may be brought into a conducting state, or not.

The supply circuit 1,2 comprises the primary circuit 1 and the secondary circuit 2 for providing an output signal to the load 3. The average output signal may depend on a number of first states versus a number of second states, whereby each state may correspond with a mode and/or with one or more of the states of an inverter.

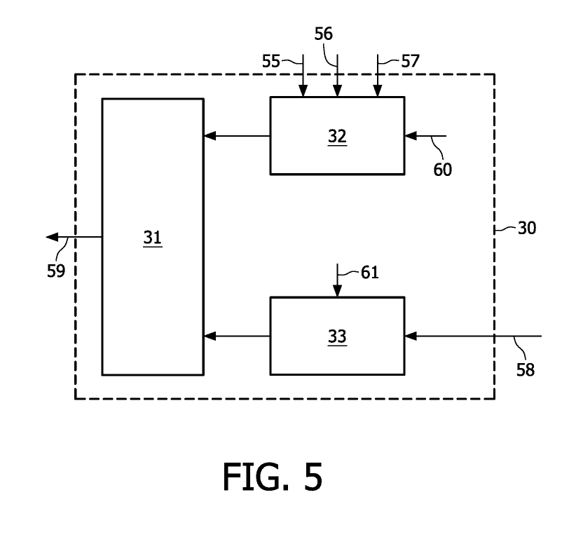

The converter circuit 30 shown in the FIG. 5 in greater detail comprises a first processing block 3 1, a second processing block 32 and a third processing block 32. Via at least one of the connections 55-57, the converter circuit 30 receives the primary circuit signal, and via a connection 60, an adjustment signal may be supplied to this second processing block 32 that processes these signals and that supplies a result signal to the first processing block 31. Via the connection 58, the converter circuit 30 receives the one or more threshold values, and via a connection 61, an adjustment value may be supplied to this third processing block 33 that processes these values and that supplies a further result signal to the first processing block 31. This first processing block 31 processes the result signals and in response generates the control signal to be supplied via the connection 59 to the control circuit 40 etc. From the control signal supplied via the connection 59, the signals to be supplied via the connections 51, 52, 53 and 54 for the switches of the half-bridge or the full-bridge are generated. Preferably, a control scheme ensures an equal average current load in all switches to provide identical conduction losses in all switches.

The invention describes a novel resonant driver topology that for example provides galvanic isolation for LEDs and that is based on an appropriate control scheme. The transformer serves for galvanic isolation and adapts a voltage level, e.g. from 300V to 30V. A resonant topology is formed by the stray inductance of the transformer, an optional inductance and a series capacitor. Thus, the parasitic leakage inductance of the transformer is part of the driver. Contrary to pulse width modulation based converters such as forward or fly-back topologies, the leakage inductance does not need to be minimized. This is of advantage for the isolation and winding design and it thus keeps the cost low. Alternated positive and negative voltage pulses may be generated. The polarity of the voltage may be identical to the polarity of the current. The frequency depends on the resonant frequency of the resonant elements. The current in the LEDs (and by that also the LED light output) is controlled using a zero current switching strategy to reduce losses and electromagnetic interference. As a result it may be decided on a high frequency basis to transfer energy (on-state) from a primary side to a secondary side or not (off-state). The average light output of each one of the LED strings may depend on the number of on-states versus the number of off-states.

This provides the following advantages:
The current in the driver becomes sinusoidal and it is zero at the switching instants. This avoids switching losses and minimizes electromagnetic interference.
The current control is done at the primary side and thus, no additional measurements have to be done at the galvanic isolated secondary.
The nominal output voltage can be set by the turns ratio of the transformer.
The lighting system is very suitable for mains supply.
A dimming function for the brightness of the LEDs can easily be installed. This enables color control in systems with more than one LED color (string).

The system described is intended to supply and regulate the power for a LED lamp consisting of either one or more different LED colors. The resonant power supply consists of a high frequency ac-inverter which provides a rectangular voltage waveform at the output terminals. The resonant inverter can be realized by means of a half-bridge or full-bridge inverter. The rectangular output voltage is either in phase to the output current or it is zero or it is in anti-phase to the output current. To keep the output voltage in phase to the output current, for example the current is measured and its zero crossing is detected.

In one embodiment the controlled variable can be a low-pass filtered absolute value of the resonant current. If this variable is below the set point then an output voltage will be applied that is in phase to the resonant current, thus energy will be supplied to the resonant circuit. If the controlled variable is above the set point then no more energy will be supplied to the resonant circuit. This can for example be achieved by applying zero voltage to the system.

In another embodiment the controlled variable can be a low-pass filtered weighted absolute value of the resonant current. Advantageously the weighting function can be the current to light-output dependency. In this case the controlled variable will approximate the real light output.

The reference value for the desired light output is set by means of a reference signal or digital information. While switching the switches in the resonant inverter an operation with low switching losses is achieved since the switches are commutating at nearly zero current. Thus, the resonance frequency can be very high. The resonant frequency is determined by the resonant capacitor and the total resonant inductance. The resonance impedance of the resonant circuit acts as a series resistance and limits the primary and secondary winding current in the transformer. In one embodiment a rectifier circuit is connected to the transformer secondary side. The rectified output voltage supplies one or more LED-arrays. In another embodiment of the invention the LEDs themselves act as a rectifier circuit.

With respect to different current and voltage demands of the LED-arrays, each of the branches may be provided with an additional series resistor. The light output of each of the branches is determined by the number of on-cycles versus the number of off-cycles. Since all branches can be controlled the brightness of the LEDs can be set in a wide range. FIG. 4 shows an example of the current in each of the branches. The control method applies a converter voltage that is in phase to the current, when the actual current is smaller than the reference current. It applies a zero (or out of phase converter voltage) if the actual current is above the reference value. This method guarantees that switching events only happen when the resonant current is nearly zero, thus switching losses are minimized.

The resonant inverter can be supplied from a dc-voltage source. The transformer turns ratio depends on the dc-input voltage and the number of series connected LED. As more LEDs are connected in series the total forward voltage drop will be higher and a different transformer turns ratio is required. When operating from the mains or from a different ac-voltage, the inverter can be connected by means of a bridge rectifier to the ac-voltage terminals. Optionally the rectified ac-voltage can be smoothed by means of a dc-smoothing capacitor. At higher power levels mains supplied power supplies have to fulfill mains current regulations. Those could be addressed by means of an active mains filtering. The active mains filter provides at the output terminals a constant dc-voltage. Furthermore, the resonant inverter can be mechanically separated from the transformer and the rest of the resonant circuit, which may be useful for movable mains supplied illumination products.

Summarizing, a primary circuit 1 for feeding a secondary circuit 2 comprises a switch circuit 10 with switches 11-14 controlled by a control circuit 40 for bringing the primary circuit 1 into first or second modes and comprises a resonance circuit 20 for, in the first mode, increasing an energy supply from a source 4 to the secondary circuit 2 via in-phase resonance circuit voltages and currents and for, in the second mode, not increasing the energy supply to the secondary circuit 2 via not-in-phase resonance circuit voltages and currents and comprises (basic idea) a converter circuit 30 for converting a primary circuit signal into a control signal for the control circuit 40 for bringing the primary circuit 10 into the first mode or into the second mode in dependence of the control signal, according to a zero current switching strategy for reducing losses and electromagnetic interference.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Primary circuit for feeding a secondary circuit, the primary circuit comprising:
a switch circuit comprising switches controlled by a control circuit for bringing the primary circuit at least into a first mode or into a second mode,
a resonance circuit for, in the first mode, increasing an energy supply from a source to the secondary circuit via a first voltage across the resonance circuit and a first current through the resonance circuit that are in phase with each other and for, in the second mode, not increasing the energy supply to the secondary circuit (2) via a second voltage across the resonance circuit and a second current through the resonance circuit that are not in phase with each other, and
a converter circuit for converting a primary circuit signal into a control signal for the control circuit for bringing the primary circuit into the first mode or into the second mode in dependence of the control signal.

2. The primary circuit of claim 1, wherein the resonance circuit is arranged, in the second mode, to supply energy back to the source via a second voltage across the resonance circuit and a second current through the resonance circuit that are in anti-phase with each other and/or to block a transfer of energy via a fixed voltage across the resonance circuit.

3. The primary circuit of claim 2, wherein:
the switch circuit is a full bridge inverter,
the first mode being an energy supplying state of the full bridge inverter, and
the second mode being either an idle state of the full bridge inverter or an energy retrieving state of the full bridge inverter.

4. The primary circuit of claim 3, wherein:
the primary circuit signal is the current through the resonance circuit,
a first group of values of the control signal result in the energy supplying state,
a second group of values of the control signal result in the idle state, and
a third group of values of the control signal result in the energy retrieving state.

5. The primary circuit of claim 2, wherein:
the switch circuit is a half bridge inverter,
the first mode is an energy supplying state of the half bridge inverter, and
the second mode is an energy retrieving state of the half bridge inverter.

6. Primary circuit (1) as defined in claim 5, the primary circuit signal being the current through the resonance circuit, a fourth group of values of the control signal resulting in the energy supplying state, and a fifth group of values of the control signal resulting in the energy retrieving state.

7. The primary circuit of claim 4, wherein the control signal is a low-pass filtered absolute value or a low-pass filtered weighted absolute value of the current through the resonance circuit.

8. Supply circuit comprising the primary circuit, comprising
a switch circuit comprising switches controlled by a control circuit for bringing the primary circuit at least into a first mode or into a second mode,
a resonance circuit for, in the first mode, increasing an energy supply from a source to the secondary circuit via a first voltage across the resonance circuit and a first current through the resonance circuit that are in phase with each other and for, in the second mode, not increasing the energy supply to the secondary circuit via a second voltage across the resonance circuit and a second current through the resonance circuit that are not in phase with each other, and
a converter circuit for converting a primary circuit signal into a control signal for the control circuit for bringing the primary circuit into the first mode or into the second mode in dependence of the control signal.

9. The supply circuit of claim 8, further comprising the secondary circuit for providing an output signal to a load, the average output signal depending on a number of first states versus a number of second states.

10-13. (canceled)

14. The primary circuit of claim 6, wherein the control signal is a low-pass filtered absolute value or a low-pass filtered weighted absolute value of the current through the resonance circuit.
